(19) United States
(12) Patent Application Publication
(10) Pub. No.: US 2009/0025061 A1
(43) Pub. Date: Jan. 22, 2009

(54) CONDITIONAL PEER-TO-PEER TRUST IN THE ABSENCE OF CERTIFICATES PERTAINING TO MUTUALLY TRUSTED ENTITIES

(75) Inventor: David W. KRAVITZ, Fairfax, VA (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/778,963

(22) Filed: Jul. 17, 2007

(51) Int. Cl. H04L 9/32; H04L 9/30

(52) U.S. Cl. 726/4; 380/30

(57) ABSTRACT

A method, apparatus, and electronic device for protecting digital rights are disclosed. A network interface may receive a rights representation for a set of digital content from a source entity. A processor may conditionally accept the set of digital content. A memory may store a local blacklist identifying the source entity if a rights event occurs.

### FIELD OF THE INVENTION

The present invention relates to a method and system for managing access to content. The present invention further relates to protecting digital rights when managing access to content.

### INTRODUCTION

When peer-level entities communicate with one another, such communication may include mutual authentication based on the use of certified public keys and corresponding private keys. Each entity may use the certified public key of the other entity and each entity may use its own private key. Each entity may determine that an appropriate certification authority has properly certified the other entity's public key. The source peer entity may send data to the sink peer entity. When such data is sent, a content encryption key may be used to derive plaintext (i.e., usable) content from available ciphertext, or encrypted content. Unfortunately, the sink entity may not always detect that a source entity has been compromised because, for example, the sink entity does not have access to the most current certificate revocation list or because the compromise is unknown to the certification authority. If the source entity has been compromised in a way undetectable to the sink entity, the source entity may successfully fabricate or alter the transaction in order to conduct illicit activity. For example, particular content encryption keys may be intended by a rights issuer to never be forwarded or to be forwarded across peer entities only a limited number of times. Such out-of-band or offline activity (i.e., activity occurring without the specific presence of the rights issuer) needs to be securely managed.

### SUMMARY OF THE INVENTION

A method, apparatus, and electronic device for protecting digital rights are disclosed. A network interface may receive a rights representation for a set of digital content from a source entity. A processor may conditionally accept the set of digital content. A memory may store a local blacklist identifying the source entity if a rights event occurs.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram a peer-to-peer digital content network.

FIG. 2 illustrates in a block diagram a rights tracking table.

FIG. 3 illustrates in a block diagram a rights representation.

FIG. 4 illustrates in a flowchart a method of conditional trust in peer-to-peer digital content rights transfer.

FIG. 5 illustrates in a flowchart one embodiment of a reporting scheme.

FIG. 6 illustrates a possible configuration of a computer system to act as a mobile system or location server to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for protecting digital rights are disclosed. A network interface may receive a rights representation for a set of digital content from a source entity. A processor may conditionally accept the set of digital content. A memory may store a local blacklist identifying the source entity if a rights event occurs.

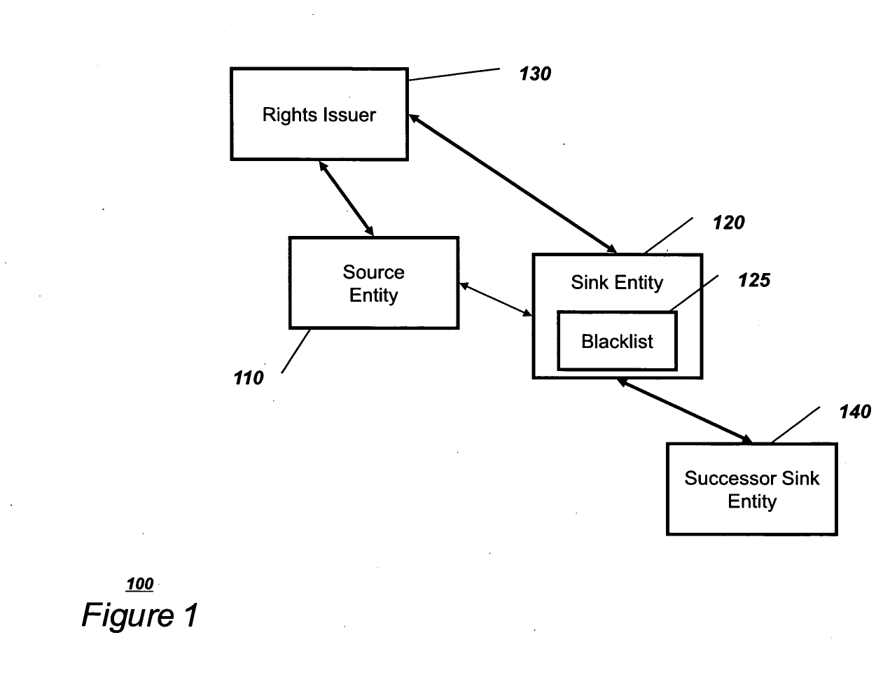

FIG. 1 illustrates in a block diagram a peer-to-peer digital content network 100. Each of the devices or entities in the network may be any type of mobile computing device, such as a mobile telephone handset. A source entity 110, or mobile computing device providing digital content, may transfer digital content to a sink entity 120, or mobile computing device receiving digital content. The digital content may be digital media, software, data, or other digitally transferable content. Alternatively, the sink entity 120 may receive the digital content, which may be ciphertext or encrypted content, partially or wholly, from a source or sources independent of the source entity 110 that delivers the rights or access to content. The source entity 110 may send a rights representation and a rights issuer representation to the sink entity 120. The rights representation indicates the right to use the digital content. The rights issuer representation, when used in conjunction with a rights representation, indicates the source entity 110 has received permission from the rights issuer 130 the right to distribute the digital content identified in the rights representation. Such conveyance of information from the source entity 110 to the sink entity 120 may also include delivery of information that enables use of the rights representation, such as information that enables access to a germane content encryption key. In the interests of conserving memory space and bandwidth, the rights issuer representation need not include the entire certificate chain pertaining to the rights issuer, where generally a plurality of rights issuers occurs. Instead, the sink entity 120 may conditionally accept the digital content, until such time as the verification or validation of the rights representation and the rights issuer representation contradicts data stored by the sink entity 120. Once the sink entity 120 becomes aware of a rights event, the source entity 110 may be placed on a local blacklist 125 stored on the sink entity 120, the local blacklist 125 banning future digital rights transactions with that source entity 110. A rights event may be any occurrence that alerts the sink entity 120 to any problem with the rights to the digital content. For example, a rights event may be data returned from a trusted third party indicating that the rights representation received from the source entity 110 was invalid. Once a source entity 110 is stored locally on the blacklist 125, the sink entity 120 may refuse information pertaining to use of or access to digital content from that source entity 110. The sink entity 120 may also discontinue or decline to initiate use of or access to digital content corresponding to rights representations that were received prior to ascertaining that the associated received rights issuer representation was invalid.

The sink entity 120 may have a pre-set limit on the permitted number of transactions, each involving a specific rights issuer representation that has not been previously validated. Once that pre-set limit is reached, the sink entity 120 may be required to ascertain rights issuer representation validation concerning the various alleged rights issuers 130. The validated rights issuer representation may take the form of certificate chain information. The sink entity 120 may acquire validation for all stored rights issuer representations when one rights issuer representation is verified. Alternatively, the sink entity 120 may be programmed to randomly choose which non-validated rights issuer representations are to be validated first. Once a sink entity 120 has validated a rights issuer representation, the sink entity 120 acting in the role of a source entity 110 may transmit access to the digital content based on the verified rights issuer representation and the verified rights representation to a successor sink entity 140 without incurring the risk of being legitimately blacklisted based on misrepresented rights. A source entity 110 need not always communicate a rights issuer representation to a sink entity 120 when transmitting a rights representation for a set of digital content if the sink entity 120 indicates that it already has a validated version of the germane rights issuer representation.

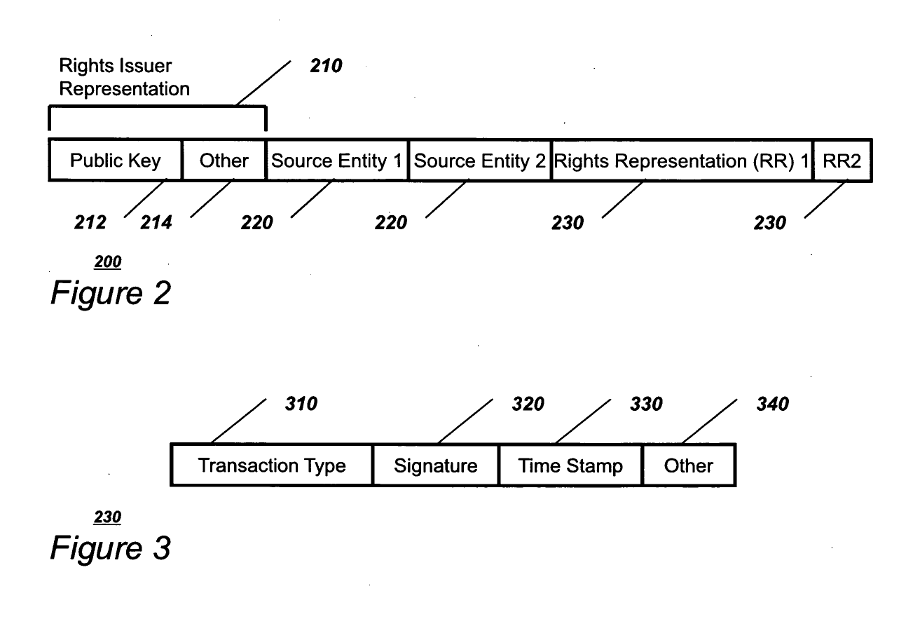

FIG. 2 illustrates in a block diagram a rights tracking table 200. The rights tracking table 200 may be used by a sink entity 120 to track the permissions granted to the sink entity, and the source entity grantor of the permissions. The rights tracking table 200 stores a rights issuer representation (RIR) 210 and a source entity identifier (SEID) 220 for the source entity 110 that provided the RIR 210. Each RIR 210 may have a rights issuer public encryption key 212 and any other RIR data 214 usable to uniquely identify the rights issuer certificate. The rights issuer public encryption key 212 may be used for signature verification and message encryption, or may be used solely for signature verification. If a source entity 110 provides the same RIR 210 as provided by a previous source entity 110, the SEID 220 for the new source entity 110 is appended to the stored RIR 210. The rights tracking table 200 is one element of the process that enables a sink entity 120 to determine if a source entity 110 is misrepresenting its rights to the digital content, so that the source entity 110 may be blacklisted if need be. Appended to or referenced by the RIR 210 may be the one or more rights representation (RR) 230 that are communicated to the sink entity 120 by one of the source entity 110 associated with the particular RIR 210.

FIG. 3 illustrates in a block diagram a RR 230. The RR 230 may contain the type of transaction 310 that granted the source entity 110 the authorization to provide the rights representation 230 corresponding to digital content, and the actual digital signature 320 of the rights issuer 130 over at least a portion of the rights representation data. The sink entity 120 may verify the digital signature using the public encryption key 212 in the RIR 210. Once the conditionally accepted RIR 210 has been verified or validated, an associated RR 230 may be considered valid as well. The RR 230 may contain a timestamp 330 signifying the time that the rights representation was provided by the source entity 110 to the sink entity 120. The RR 230 may also contain any other necessary additional information 340 that is needed to process the content rights.

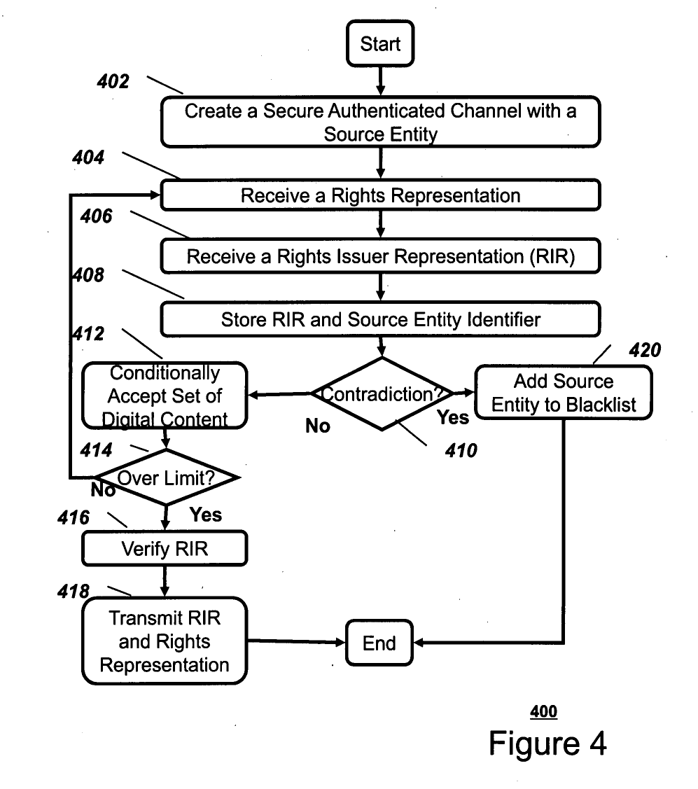

FIG. 4 illustrates in a flowchart a method of conditional trust in peer-to-peer digital content rights transfer. The sink entity 120 may create a secure authenticated channel with the source entity 110 (Block 402). Such a secure authenticated channel may be created through the mutual exchange of public keys. The sink entity 120 may receive a rights representation 230 corresponding to a set of digital content from the source entity 110 (Block 404). The sink entity 120 may receive a RIR 210, which may include a source entity identifier (SEID) (Block 406). The sink entity 120 may then store the RIR 210 and the SEID 220 (Block 408). If the RIR 210 does not contradict digital rights data currently stored with the sink entity 120 (Block 410), then the sink entity 120 may conditionally accept the RIR 210 and the RR 230 corresponding to the set of digital content (Block 412). If the number of conditional transactions is not over the set limit for the sink entity 120 (Block 414), the sink entity 120 may accept more transactions corresponding to digital content (Block 404). Once the limit has been met (Block 414), the sink entity 120 verifies the non-validated RIR 210 values by requesting the appropriate certificate chains (Block 416). The sink entity 120 may transmit the verified RIR and rights representation 230 corresponding to a set of digital content to successor sink entities 140 (Block 418). If an incoming RIR 210 does contradict a previously validated RIR 210 value currently stored with the sink entity 120 (Block 410), the sink entity 120 may add the source entity 110 to the locally stored blacklist 125 (Block 420), at which point no further transactions corresponding to digital content are accepted by the sink entity 120 from the source entity 110. Similarly, if a newly validated RIR 210 contradicts a previously stored conditionally accepted RIR 210, the sink entity may add the one or more source entity 110 corresponding to the conditionally accepted RIR 210 to the locally stored blacklist 125.

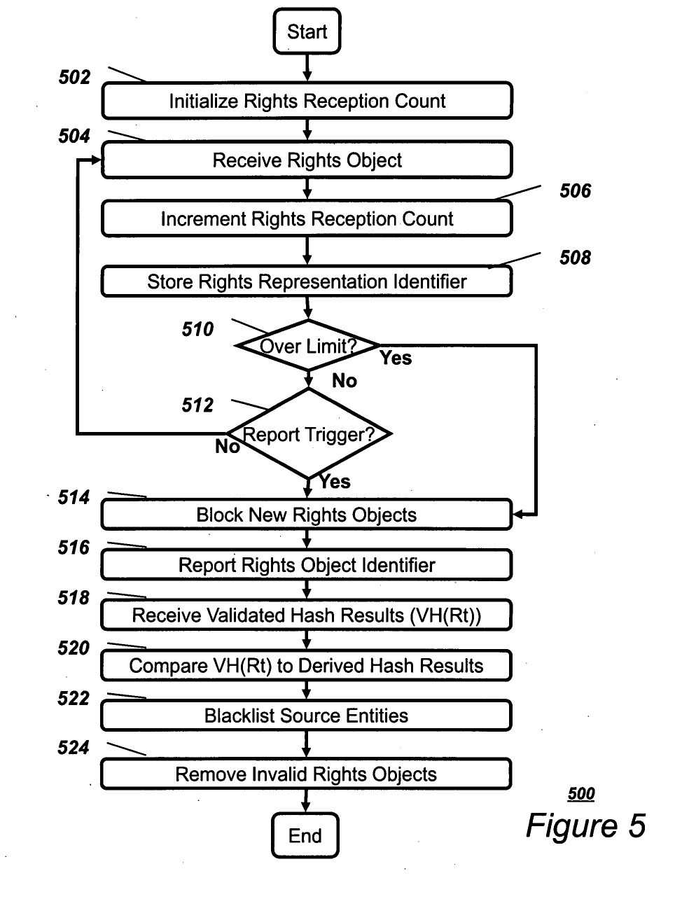

FIG. 5 illustrates in a flowchart one embodiment of a reporting scheme 500. The reporting scheme 500 may use a device-centric approach that uses a threshold-based reporting mechanism to reactively reduce the propagation of counterfeit or altered rights, with minimal to no impact on possibly constrained-resource entities such as secure removable media (SRM) cards or modules, on the construction by a rights issuer 130 of an initial rights object (RO), or on the request and delivery mechanisms used in conjunction with the initial RO, such as a rights object acquisition protocol (ROAP). The reporting scheme 500 may obviate the need for the source entity 110 or the sink entity 120 to store any RIR 210. A sink entity 120 may initialize a count the first time it directly renders or consumes content associated with a rights object or rights representation received from an SRM or other source entity 110 (Block 502). Each time a new rights object is received and used for directly rendering or consuming content (Block 504), the sink entity may increment the count (Block 506). The sink entity 120 may store in a table an identifier of a rights representation, such as a rights object identifier (ROID); a result of a one-way hash function of the stored rights object (DH(Rt)); and an SRM identifier (SRM ID) or, more generally, a source entity ID, for the source entity 110 that provided the rights (Block 508). The table may retain this data even if the rights are moved or transferred from the sink entity in a subsequent role as a source entity after initially storing the data. A reporting threshold, based on a set number of transactions, may be used to limit the number of rights objects or rights representations that are outstanding. This limit may be useful as the sink entity 120 has not received, from a trusted third party, indicative data that can be used by the sink entity 120 to determine whether or not the rights objects or rights representations received from one or more instances of the source entity 110 are valid. If a reporting threshold is not reached (Block 510) and no report-triggering event occurs (Block 512), the sink entity 120 may wait to receive a new rights object (Block 504). If a reporting threshold is reached (Block 510) or a report-triggering event occurs (Block 512), the sink entity 120 may block the receipt of any new rights objects (Block 514). If a reporting threshold is reached, the sink entity 120 may also decline to initiate direct rendering or consumption of rights objects that have not been verified as valid. The sink entity 120 may report the stored ROIDs to a trusted third party (Block 516) and receive from that trusted thirty party the appropriate validated results of a one-way hash function of the stored rights object (VH(Rt)) (Block 518). For each rights object, the sink entity may compare the VH(Rt) to the DH(Rt) for that rights object (Block 520). If there is not an exact match, the rights object corresponding to the stored ROID may be considered invalid by the sink entity 120. If the trusted third party does not recognize a ROID value as legitimate, such indication of an invalid rights object may be returned to the sink entity 120. The sink entity 120 may blacklist those source entities 110 that are found to have transmitted invalid rights objects (Block 522). The sink entity 120 may also remove any invalid rights objects from its storage, thus precluding their transfer or further consumption (Block 524). Reporting may occur in advance of reaching a threshold so as to avoid interruption of service. A reporting scheme such as exhibited here may provide a level of security without relying on rights issuers to incorporate a digital signature into rights objects for the use of a sink entity in processing a rights object received from a source entity. If such digital signature is not embedded into rights object or not used by a sink entity, there may be no need for a sink entity to access rights issuer public key information or to validate rights issuer certificate chain information in order to process peer-to-peer transaction data received from a source entity.

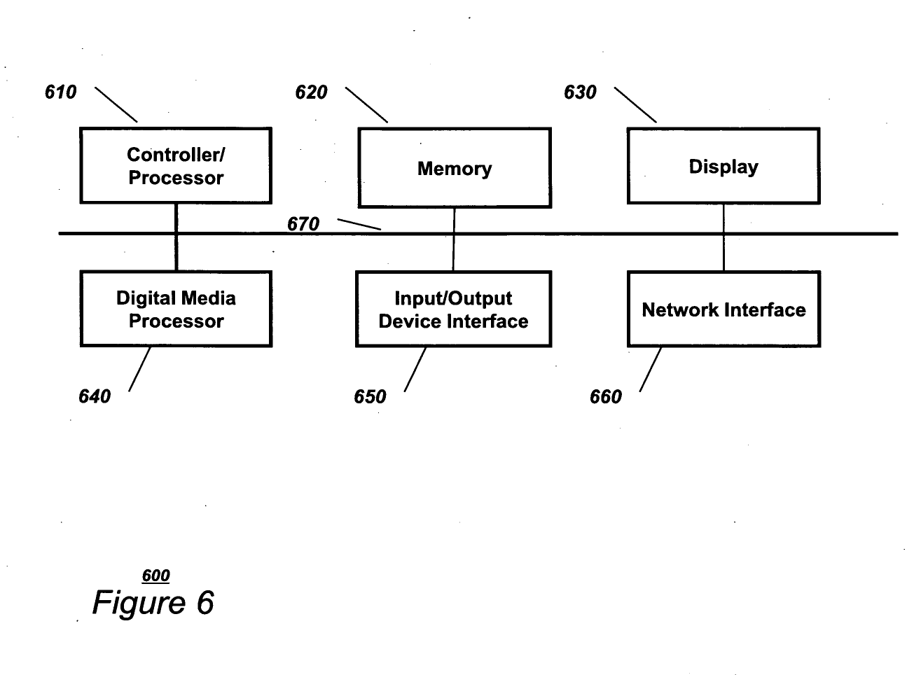

FIG. 6 illustrates a possible configuration of a computing system 600 to act as a mobile telecommunications apparatus or electronic device to execute the present invention. The computer system 600 may include a controller/processor 610, a memory 620, display 630, a digital media processor 640, input/output device interface 650, and a network interface 660, connected through bus 670. The computer system 600 may implement any operating system, such as Windows or UNIX, for example. Client and server software may be written in any programming language, such as C, C++, Java or Visual Basic, for example.

The controller/processor 610 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 620 may include volatile and nonvolatile data storage, including one or more electrical, magnetic or optical memories such as a random access memory (AM), cache, hard drive, or other memory device. The memory may have a cache to speed access to specific data. The memory 620 may also be connected to a compact disc-read only memory (CD-ROM, digital video disc-read only memory (DVD-ROM), DVD read write input, tape drive or other removable memory device that allows media content to be directly uploaded into or downloaded from the system.

The digital media processor 640 is a separate processor that may be used by the system to more efficiently present digital media. Such digital media processors may include video cards, audio cards, or other separate processors that enhance the reproduction of digital media.

The Input/Output interface 650 may be connected to one or more input devices that may include a keyboard, mouse, pen-operated touch screen or monitor, voice-recognition device, or any other device that accepts input. The Input/Output interface 650 may also be connected to one or more output devices, such as a monitor, printer, disk drive, speakers, or any other device provided to output data.

The network interface 660 may be connected to a communication device, modem, network interface card, a transceiver, or any other device capable of transmitting and receiving signals over a network. The network interface 660 may be used to transmit the media content to the selected media presentation device. The network interface may also be used to download the media content from a media source, such as a website or other media sources. The components of the computer system 600 may be connected via an electrical bus 670, for example, or linked wirelessly.

Client software and databases may be accessed by the controller/processor 610 from memory 620, and may include, for example, database applications, word processing applications, the client side of a client/server application such as a billing system, as well as components that embody the decision support functionality of the present invention, such as the blacklist 125 or the rights tracking table 200. The computer system 500 may implement any operating system, such as Windows or UNIX, for example. Client and server software may be written in any programming language, such as C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for protecting digital rights, comprising:
receiving a rights representation for a set of digital content from a source entity;
conditionally accepting the rights representation;
adding the source entity to a local blacklist if a rights event occurs; and
refusing future digital rights transactions with that source entity.

2. The method of claim 1, further comprising reporting an identifier of the rights representation to a trusted third party.

3. The method of claim 1, further comprising receiving a rights issuer representation for the rights representation from the source entity.

4. The method of claim 3, further comprising storing the rights issuer representation with a source entity identifier.

5. The method of claim 3, wherein the rights issuer representation includes a public encryption key.

6. The method of claim 3, further comprising verifying the rights issuer representation after a set number of transactions.

7. The method of claim 1, further comprising verifying the rights representation.

8. The method of claim 7, further comprising transferring a verified rights representation corresponding to the set of digital content to a successor sink entity.

9. A telecommunications apparatus that protects digital rights, comprising:
a network interface that receives a rights representation for a set of digital content from a source entity;
a processor that conditionally accepts the rights representation and adds the source entity to a local blacklist if a rights event occurs; and
a memory that stores the local blacklist banning future digital rights transactions with the source entity.

10. The telecommunications apparatus of claim 9, wherein the network interface reports an identifier of the rights representation to a trusted third party.

11. The telecommunications apparatus of claim 9, wherein the network interface receives a rights issuer representation for the rights representation from the source entity.

12. The telecommunications apparatus of claim 11, wherein the memory stores the rights issuer representation with a source entity identifier.

13. The telecommunications apparatus of claim 11, wherein the rights issuer representation includes a public encryption key.

14. The telecommunications apparatus of claim 11, wherein the processor verifies the rights issuer representation after a set number of transactions.

15. The telecommunications apparatus of claim 9, wherein the processor verifies the rights representation.

16. The telecommunications apparatus of claim 15, wherein the network interface transfers a verified rights representation and set of digital content to a successor sink entity.

17. An electronic device that protects digital rights, comprising:
a network interface that receives a rights representation for a set of digital content from a source entity;
a processor that conditionally accepts the rights representation and adds the source entity to a local blacklist if a rights event occurs; and
a memory that stores the local blacklist banning future digital rights transactions with the source entity.

18. The electronic device of claim 17, wherein the network interface reports an identifier of the rights representation to a trusted third party.

19. The electronic device of claim 17, wherein the network interface receives a rights issuer representation for the rights representation from the source entity.

20. The electronic device of claim 17, wherein the processor verifies the rights representation.
